(19) United States
(12) Patent Application Publication
(10) Pub. No.: US 2007/0226616 A1
(43) Pub. Date: Sep. 27, 2007

(54) Method and System For Wide Area Security Monitoring, Sensor Management and Situational Awareness

(75) Inventors: Nikhil Gagvani, Monmouth, NJ (US); Supun Samarasekera, Princeton, NJ (US); Vincent Paragano, Yardley, PA (US); Manoj Aggarwal, Lawrenceville, NJ (US)

Correspondence Address: TIAJOLOFF & KELLY, CHRYSLER BUILDING, 37TH FLOOR, 405 LEXINGTON AVENUE, NEW YORK, NY, 10174, US

(73) Assignee: L-3 Communications Corporation, New York, NY (US)

(21) Appl. No.: 11/628,342

(22) PCT Filed: Jun. 1, 2005
(86) PCT No.: PCT/US05/19681

§ 371 Date: Dec. 1, 2006

Related U.S. Application Data
(60) Provisional application No. 60/575,894, filed on Jun. 1, 2004.
(60) Provisional application No. 60/575,895, filed on Jun. 1, 2004.
(60) Provisional application No. 60/576,050, filed on Jun. 1, 2004.

(51) Int. Cl. G06F 3/00

(52) U.S. Cl. 715/700

(57) ABSTRACT

A security system comprises a computer network and a plurality of sensors each connected to the computer network at a respective network address and each generating sensing data. A managing component is connected with the network and communicates with the sensors by access thereof through the associated network address on the network, and processes sensor information received from said sensors. The managing component has a display with an interface screen showing to a user all the sensors in the security system, and an input device through which the user can enter interactive instructions to the managing component. The managing component controls communications to and from the sensors and has a rules engine storing rules therein. Each of the rules being associated with a respective device on the network, and causing the managing computer to take an action in response to output from at least one of the devices.

### RELATED APPLICATIONS

This application claims priority of U.S. provisional application Ser. No. 60/575,895 filed Jun. 1, 2004 and entitled “METHOD AND SYSTEM FOR PERFORMING VIDEO FLASHLIGHT”, U.S. provisional patent application Ser. No. 60/575,894, filed Jun. 1, 2004, entitled “METHOD AND SYSTEM FOR WIDE AREA SECURITY MONITORING, SENSOR MANAGEMENT AND SITUATIONAL AWARENESS”, and U.S. provisional application Ser. No. 60/576,050 filed Jun. 1, 2004 and entitled “VIDEO FLASHLIGHT/VISION ALERT”.

### FIELD OF THE INVENTION

The present invention generally relates to surveillance systems, and especially to systems and methods for managing sensor devices and viewing data for situational awareness in a surveillance system, such as, e.g., the VIDEO FLASHLIGHT™ system, described in U.S. published patent application 2003/0085992 published on May 8, 2003, herein incorporated by reference, in which videos from a number of cameras in an particular site or environment are managed by overlaying the video from these cameras onto a 2D or 3D model of a scene.

### BACKGROUND OF THE INVENTION

Over the years, security has become of major importance. The number of sites or regions in which surveillance is desired has increased. As the number of sites has increased, so has the demand for the number of surveillance security systems. In an environment in which surveillance of a large site or region is desired, a conventional system typically monitors the activity within the site or region using a variety of sensors including video, radar, RFID and access control. The sensors are positioned throughout a site or region, and the sensors provide event (or threat) information relating to the activity within the site or region. For example, an event may be an alarm, video stream or other information sensed by a sensor in an area of the site or region.

Not only has the demand for the quantity of security systems increased, so has the demand for more sophisticated surveillance techniques and technology to enable an operator to monitor and manipulate sensors located even across the globe. Existing systems, however, normally do not provide for the flexibility of communication or the introduction of distant sensors or components into a security surveillance system.

Also, certain surveillance systems of the prior art do not provide a full and clear picture of the activity in the area or region. For example, it would be preferable to view all sensors on a single display, but this is not provided in earlier designed systems, and, frequently, only event information from one sensor can be viewed at a time on a display. Furthermore, event information is usually viewable or accessed only within the site or region in which the sensor is located. Event information from one (remote) site cannot be accessed by another site (locally).

In the current environment, sensors are located across the globe at various sites (typically located great distances from the local site or region) and it would be desirable to have remote access. In addition, these conventional systems do not enable security personnel to configure the sensors as desired locally or remotely. Finally, event information is rarely received instantaneously.

There is therefore a need for a method and system that will overcome the disadvantages of earlier systems.

### SUMMARY OF THE INVENTION

A security system is disclosed in which several separate sites or regions are connected over a network. A variety of sensors are available at each networked site along with its own system and network, devices, computers and sensors. The system includes an assembly of software components that run in a distributed manner on the networked sites. The security system with these software components makes all sensors visible in an integrated display from any site. Further, the security system provides for configuration, control and display of the sensors as well the recording and retrieval of sensor information from any site. Instantaneous sensor information is therefore achieved, and the system can be scaled up readily and without substantial limitations.

In accordance with an aspect of the invention, a security system comprises a computer network and a plurality of sensors each connected to the computer network at a respective network address and each generating sensing data. A managing component is connected with the network and communicates with the sensors by access thereof through the associated network address on the network, and processes sensor information received from said sensors. The managing component has a display with an interface screen showing to a user all the sensors in the security system, and an input device through which the user can enter interactive instructions to the managing component. The managing component controls communications to and from the sensors and has a rules engine storing rules therein. Each of the rules being associated with a respective device on the network, and causing the managing computer to take an action in response to output from at least one of the devices.

According to another aspect of the invention, a security system comprises a computer network, a plurality of managing modules each connected with the computer network, and a plurality of sensors, each connected with a respective managing module by a communication link other than the network. Each managing module has a rules engine defining at least one action to be taken in reaction to an output from one of the sensors. One of the managing modules receives a transmission over the network from another of the managing modules acting as a proxy server for a sensor attached thereto and displays on a display device thereof data from the sensor.

According to still another aspect of the invention, a method of security monitoring and management comprises providing a modular managing terminal connected with a network to which are connected a plurality of sensor devices each having a respective IP address. Communications with the sensor devices are configured for the managing terminal. Transmissions from the sensor devices over the network are received at the managing terminal. A rules engine is maintained at the managing module. The rules engine has stored a respective rule for each of said sensor devices, the rule for each device determining whether the managing module takes no action in response to a transmission from the associated device or takes an associated action in response to said transmission from said device.

Other objects and advantages of the present invention will be apparent to those of skill in the art with the present disclosure before them.

### BRIEF DESCRIPTION OF THE DRAWINGS

FIG. 1 illustrates a security system according to a preferred embodiment of the present invention.

FIG. 2 is an exemplary screen shot of a computer display operating with the system of the present invention displaying the capabilities and functionalities of the system.

### DETAILED DESCRIPTION OF THE PREFERRED EMBODIMENT

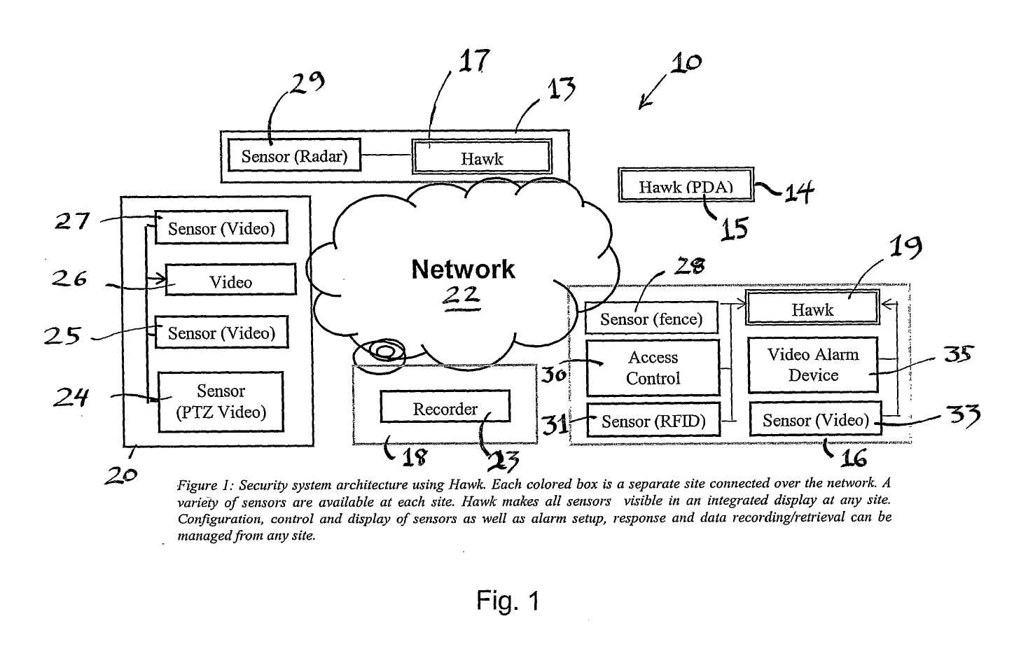

FIG. 1 shows security system 10 in accordance with a preferred embodiment of the present invention. The security system includes an assembly of software components that run in a distributed manner on a set of networked “sites” or instances, each of which includes potentially its own system, network, devices, computers and sensors. Generally, the security system is run by one or more HAWK terminals, which are supported either on a PC computer with the usual components, i.e., RAM, disk drive and other data storage devices, a mouse, a keyboard and a monitor or a display, or else on a PDA, with the usual connectivity and I/O alternatives thereof, and connected with the network.

The HAWK terminals are modular devices that act as front-end user access devices with GUI or other interactive interface displays and input devices, and also as servers or connection managers controlling communication among devices across the network based on a set of rules running on an internal rule engine in each HAWK terminal that defines its relationship with each of the devices on the network.

In the simplest of HAWK systems, a single HAWK terminal is connected with a network, and there are a number of sensor devices, such as detectors, cameras, etc., connected to the network as well. The HAWK terminal communicates with each of the devices through the network and receives data from the devices as well as transmitting commands to the various devices that manages the communications through the network based on a rule engine in the HAWK terminal that takes specific pre-determined actions in response to pre-defined device events. The device events can be alarms when something is detected, or a machine condition, or virtually any hardware or software event that can result in the device issuing an output. On receipt of the output, the HAWK terminal applies the rule relevant to the outputting device and takes whatever action is specified by the rule, which can be no action, or any command possible for the device or devices on the network.

For example, a simple rule for a HAWK terminal might be “if motion detector 1 senses motion, turn camera 2 to point in a preset direction”. Other rules might be “if camera 2 transmits images, direct camera 2 to transmit its video to digital video recorder 1 on the network for recording”. More complex rules, including some that affect the display shown to the operator or administrator on the screen of the HAWK terminal display device associated with the PC computer supporting the HAWK terminal software and functionalities, may be created, such as “if smoke detector 1 is activated and motion detector 1 has been triggered more than three times in the last hour, and if it is after midnight on a weekend, then adjust camera viewing parameters for a fire condition and display a fire alarm notification to the user”. More regarding rules will be set out below.

An exemplary more complex and extended security system 10 includes five sites 13, 14, 16, 18, 20 connected via network 22, three of which have a HAWK terminal (site 14 represents a HAWK terminal in a wireless PDA which will be discussed in more detail below). In each of the HAWK terminal sites 13, 14 and 16, the HAWK terminal controls its local group of devices via a local network, or by direct connections to the devices. The HAWK terminal also is the link for its associated group of devices linking them to the network and acts as a server in network 22 Network 22 is may be a limited area network, e.g., an Ethernet network, but may also be the Internet, or another type of communications network.

Returning to FIG. 1, sites 18 and 20 contain devices, a recorder 23 and various sensors 24, 25, 26, and 27, but no HAWK terminals. Each of these devices is connected through a server to the network, and is accessible to each of the other HAWK terminals 15, 17 and 19 through the network at its IP address or URL.

Site 13 includes only a radar sensor 29 and HAWK terminal 17, while site 14 is simply a HAWK terminal program module running on a personal digital assistant or PDA and that preferably has wireless access to network 22, whether by cellular, Bluetooth, IEEE 802.11 g, or other technology. HAWK software component 15 at site 14 enables the operator to access to any sensor at any site remotely (wirelessly) using a PDA through the other HAWK terminal as a proxy or directly through the URLs of the recorder 23 or the sensor server 20.

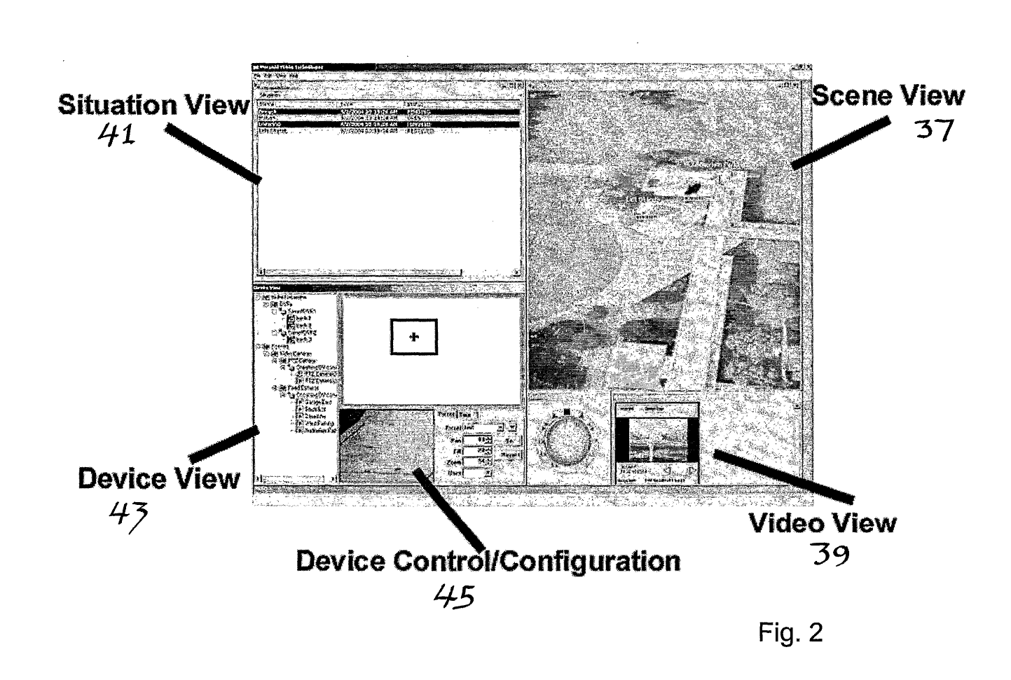

Site 16 includes a variety of sensors of different types including a fence sensor 28, an access control device 30, RFID sensor 31, video camera 33, and video alarm device 35 all connected to HAWK terminal 19, that links them to the network 22, and also provides a management functionality as shown in FIG. 2.

As seen in FIG. 2, the HAWK terminal displays a scene view or map 37 on which the sensors of the system are all identified by color codes or icons. Below this is an area 39 in which a video view shows video received from a selected sensor camera or a playback of a video from a device such as recorder 23, which is controlled by the rules of the particular HAWK terminal. The display also includes a situation view 41 that lists a set of events that the rules engine of this terminal has predetermined should be reported to the user, based on the device of the event, the severity, or a more complex determination of a course of action taken in response to events of devices. There is also a device view 43 showing all devices in the system, and a device control/configuration view 45 that allows control of a device therethrough using the interface I/O of the terminal. Controls may be directing a PTZ camera to tilt, pan or zoom in some particular way. Configuration of a device includes setting up the rule for dealing with it in the rules engine of the HAWK terminal.

Information in each window of the screen of FIG. 2 may be accessed by mouse click for example or keyboard key stroke. As in any windows environment, these windows can be resized or closed as desired. The set of these Hawk software components and the connections between them are site and operator specific. New software components may be started and plugged in, or stopped and removed based on usage and external and internal events from locally and remotely connected sensors and devices. The contents of the console and attributes of the HAWK software components are described in detail below.

Security system 10 incorporating Hawk software components allows for control, configuration and visualization of multiple sensors of all types across many sites. For example, HAWK terminal 19 can have a rule that the video from sensor 33 is to be recorded on recorder 23. When video is available, the HAWK terminal rule will cause the video to be sent to the server 18 and be recorded on recorder 23. It also allows monitoring and configuration of sensors from a single location. The security system is designed to integrate a variety of sensors including alarm hardware and provide a single platform for complete monitoring, i.e., situational awareness of a site or an arbitrary sized region such as a state, country or global security.

The organization of the various windows in the display is user-selectable, and other display windows may be set up that are similar to the windows of FIG. 2. Some of these other GUI frames are discussed below.

A. Alarm View

This is the user interface to all alarms/alert sources that are plugged into the system either locally or remotely. This situation view includes video alarms, fence alarms, access control or breach alarms, radar and other sensor alarms. These may come over the network using some protocol, or be hardwired to the HAWK security system console.

Alarms are shown in an integrated list view. This view can be sorted by time, sensor type, location, priority, acknowledge state or any other attribute of alarms. Alarm records are saved in a database that is accessible from any authorized security system console on the network. The alarm view also provides the ability to group alarms into situations based on a set of conditions. Situations can be viewed as a whole, or the constituent alarms can be seen. The operator can change the status of an alarm by acknowledging it, ignoring it or turn it off which sends a control signal to the alarming device if applicable.

This view also lets the operator view additional data related to the alarm such as a video clip, photograph, report or other data about the alarm from the alarming device.

Alarms are device events, and for each HAWK terminal in the system that has set up a communication rule with the device indicating the alarm condition, there is a rule in its rule engine for what action or actions if any are to be taken responsive to the alarm, as discussed below in greater detail.

B. Alarm Query

This display provides a query interface into a database containing the Alarms. Alarms can be searched by any attribute.

C. Large Area Visualization

This scene view displays a combination of schematics, aerial/satellite photographs, maps and 3D models of arbitrarily large regions (up to the entire globe) at varying resolutions and in a variety of formats. It is meant to provide spatial context for a security installation. Interactive navigation is possible over the region. Using the mouse, the user can pan to any latitude and longitude at any heading and zoom in or out in a continuous manner. This component provides the following functionality.
Display of sensor location at their correct position with respect to the site.
Display of sensor coverage and strength of coverage if applicable
Animated display of sensor coverage on the ground and above the ground for moving sensors
Animated display of alarms at their reported locations with graphical indications of sensor type, priority and response status. Other graphical attributes may be used to indicate additional attributes of the alarm.
Animated display of tracks from radar, video and other devices. The includes the ability to show individual or fused tracks from external fusion processors.
Display of connected devices at their appropriate locations. This display may be animated if the devices are in motion.
Display of connected users at their location.
Display of security zones
Query of location by point and click and report accurate coordinates as latitude and longitude or in site specific coordinates
Query of properties for entities shown as a graphical object. This includes alarms, devices, sensors, users, zones, etc.
Control of sensors or devices by clicking their graphical representations. This includes alarm devices, recording devices, sensors, control devices and remote the security system consoles.
Configuration of devices by clicking their graphical representations.

D. Video Viewer (VV)

This is a control to view real-time video streams. Each stream is displayed in an on-screen window and provides control for pause and zoom. This will be simple N×M Matrix of the different video feeds, where N possible video sources will be seen in one of M windows on the screen.

E. Recorder Controls

This provides playback, play-reverse, seek, pause, single step and other controls of both Digital Video Recorders and Meta-data (Alarm) recorders. Data recorders for radar and other sensors will also be controlled by this recorder. Essentially this as a device control window for a recorder, and the result of clicking or otherwise activating controls is that the HAWK terminal transmits a command signal over the network to the recorder device directing the indicated action, and receives streamed back over the network video being played back.

F. PTZ Camera Controls

This would contain controls to all the PTZ units that are connected to the system. It provides the capability to configure presets, control pan tilt and zoom functions and set up tours. When commands are entered, the HAWK terminal sends the camera commands to modify its viewing parameters, e.g., direction or zoom level. These command transmissions are either local to the HAWK terminal, as in e.g., site 16, and sent by local connection lines or network, or remote as in camera 24, in which case the signal is sent via IP address from the HAWK terminal to the IP address of the camera 24.

G. Video/Matrix Switcher Controls

This provides a graphical interface to controlling a Video Matrix switcher that would define what video feeds would go into a bank of monitors.

H. Direct Hardware Controls

This is an interactive window in the HAWK terminal that allows the terminal to transmit signals to control external devices such as TTL, Dry contact closures or serial communications. The display shows signals that are received from devices over specific hardware interfaces besides the network interface. It also allows the HAWK terminal to generate signals or dry contact to interact with devices that accept such inputs.

I. Rule Engine

The rule engine is at the heart of the security system with Hawk software components. Each HAWK terminal has a rules engine defined by stored data that tells the HAWK terminal what action to take in reaction to some event at a device in the system. The rules engine various components to be connected in a dynamic manner, and it manages and it brokers internal component connections and communications in the site and throughout the network.

Events are dynamically bound to actions that respond to those events, meaning that if an event occurs, the HAWK system will take an action prescribed by the relevant rule. This enables the security system components to be developed independently and then bound together at run time. The rule engine also starts and stops components as required in response to emerging events.

The security system supports the following functionalities which are given as examples. However, it should be noted that any other functionality that results from a combination of actions that can be individually realized by the security system is also embraced in this invention. The rule engine can dynamically tie components on the network, and route events between local or remote components which allows new functionality to be realized.

View Manipulation
Mouse controls or scrollbars for navigation over the scene.
View change to look at the position that a camera is pointed.
Alarm triggered viewpoint change: when user clicks on the alarm icon, the rule causes the view to center on the alarm location and zooms to it to a predefined level.

PTZ Based Controls
Direct control of a PTZ view using GUI buttons
Map based PTZ control: a PTZ camera points in the direction of the location clicked on the visualization view

Matrix Control
Camera selection for an output monitor
PTZ selection for an output monitor

Recorder Control
Pause
Play
Stop
Reverse
Frame Forward
Frame Reverse
Seek: slider over time and text entry field for cut/paste time

Rules
Connection Rules These define the assembly of components that comprise the security system console. This could be different for different sites of the security system. For instance the security system on a PDA may only have an alarm view, but one on a PC may have the alarm, device and visualization components. All of these views are controlled by the rules of the individual HAWK terminal involved.
Configuration Rules This allows a user to configure the system and set device and visualization parameters. Generally this allows for flexibility and also scalability of the system. It is not a complicated matter to add a large number of new sensors, for example, using this type of rule. In fact, the present system affords especially desirable scalability, meaning increase in the size of the system, because the HAWK terminals are modular and adapted to connect to the network and to flexibly control any devices that the configuration rules for the terminal devise. New devices added to the network can be accessed by their IP addresses or URLs, or by any other method when the appropriate rule for communication of the HAWK terminal to the device is set up.
Event Rules: Setting and editing rules for relationships between detected events and actions of the system. Events and actions are selected from menus and associations are established or modified by the user. These rules guide the run-time behavior of the security system and result in functionality.

Rules can be fairly intricate. For example, a rule might be “responsive to a motion detection sensor alarm, rotate a PTZ camera to cover a specific location”. Another rule could be “responsive to a high number of radar detections by a sensor increase sensitivity of sensors in an area”, or “responsive to available video from a camera, direct the recorder to record it” or “responsive to a change in temperature increase the rate of recording of video from a set of video cameras in the system”

Generally, a rule is triggered by an event of some sort with a device with which the relevant HAWK terminal is associated, and the responsive action can be anything within the range of viewing, control, management or other capabilities of the HAWK terminal acting as either a front-end interactive device or as a controller/proxy/server connected with the network 22 and with the many devices available thereon directly or through another associated HAWK terminal or locally.

User Roles

The HAWK security system supports two distinct user roles: administrator and operator. Administrators configure the various devices into a site-specific security solution. Operators use the system to monitor alarms and video and control sensors and other devices in real-time. The user interface and authorization for configuration and control is customized for the user. The security system features single logon to the network for a user who must be authorized only once.

The security system is the next step in situational awareness for security at medium-to large-scale facilities. As tactical situations become more complex and the number of sensors grows, security forces are increasingly challenged to quickly interpret and respond to emerging threats. The security system simplifies the task by creating an intuitive visual context that permits the rapid assessment of the type, location and output of multiple alarms, as well as integrated monitoring for video, radar, access control and RFID equipped facilities.

The HAWK based security system provides the following capabilities:

Visualization: Multiple-perspective geographic view of a site(s), along with visual display of information about sensor locations, coverage and alarm conditions.

Control: Ability to set or modify the operational characteristics of various sensors, including: 1) alarm parameters, alarm monitoring times and alarm options including alarm on/off; configuration and on-line control for pan/tilt/zoom (PTZ) cameras, radars, access control systems, RFID and RF location systems and matrix-switchers.

Storage: Recording and retrieval of raw or processed/analyzed sensor information (data) in time and space.

Rules: Logic for system behavior that enables users to define system function in response to an external event such as an alarm, a screen event such as a mouse click, or an internal system event, such as an operation completion.

As apparent from the diagram of FIG. 1, the security system is scalable and capable of supporting hundreds (and eventually thousands) of sensors. Expansion simply requires the connection of the new devices to the network with a discrete IP address of URL through which each can be communicated with. Larger systems having LAN networks with numerous devices can also be added by providing a HAWK terminal to act as a local proxy server connecting the LAN to the network and the resources thereon, either through HAWK terminals also acting as servers, or thorough servers linking devices directly to the network.

The system is consequently easily expandable and able to plug and play new components without disruption to system operation.

While the foregoing is directed to embodiments of the present invention, other and further embodiments of the invention may be devised without departing from the basic scope thereof.

What is claimed is:

1. A security system comprising:
a computer network;
a plurality of sensors each connected to the computer network at a respective network address and each generating sensing data relating to a respective area;
a managing component connected with the network and communicating with the sensors by access thereof through the associated network address on the network and processing sensor information received from said sensors;
said managing component having a display with an interface screen showing to a user all the sensors in the security system, and an input device through which the user can enter interactive instructions to the managing component;
said managing component controlling communications to and from said sensors and having a rules engine storing rules therein, each of said rules being associated with a respective device on said network, and causing the managing computer to take an action in response to output from at least one of said devices.

2. The security system of claim 1 wherein the display shows a description of a location of each of the sensors.

3. The security system of claim 1 wherein the display shows a coverage area of each of the plurality of sensors.

4. The security system of claim 1 wherein the sensors each transmit to the managing component a signal indicative of a condition of said sensor.

5. The security system of claim 1 wherein the plurality of sensors includes at least one camera, and said managing component directs said camera to transmit video therefrom to a recorder device connected with the network so as to record said video thereon.

6. The security system of claim 1 wherein the plurality of sensors includes a plurality of cameras, one of said cameras being a controllable camera that can have viewing parameters thereof adjusted, said managing component sending a command to said camera to cause adjustment of the viewing parameters thereof.

7. The security system of claim 6 wherein, said managing component sends the command to said camera to cause adjustment of the viewing parameters thereof in response to a transmission from another sensor on the network.

8. The security system of claim 5 wherein the managing component processes the videos and generates a map of the videos for display by the display.

9. The security system of claim 1 further comprising a configuring component providing for a user to add a sensor on the network to the plurality of sensors or to modify an aspect of communication with one of said sensors.

10. The security system of claim 1 further comprising a component storing and retrieving the sensor information under control of the managing component.

11. The security system of claim 1 wherein the plurality of sensors includes sensors that generate alarm signals in response to predetermined alarm conditions.

12. The security system of claim 11 wherein the managing component receives the alarm signals transmitted over the network, and generates a list of the alarms for the display device.

13. A security system comprising:
a computer network;
a plurality of managing modules each module connected with the computer network;
a plurality of sensors, each connected with a respective managing module by a communication link other than said network;
each managing module having a rules engine defining at least one action to be taken in reaction to an output from one of said sensors;
one of said managing modules receiving a transmission over the network from another of said managing modules acting as a proxy server for a sensor attached thereto and displaying on a display device thereof data from said sensor.

14. The security system of claim 13 wherein said one of said managing modules configures the sensor connected with said other of said managing modules by transmitting a command thereto through said other of said managing modules as a server.

15. The security system of claim 13 wherein the plurality of sensors includes one of a plurality of video devices, radar devices, access control devices, RFID and fence sensors.

16. The security system of claim 13 wherein the managing module displays information relating to a location of the sensor with the data from the sensor.

17. The security system of claim 13 wherein the data from the sensor includes a condition of the sensor.

18. A method of security monitoring and management comprising the steps of:
providing a modular managing terminal connected with a network to which are connected a plurality of sensor devices each having a respective IP address;
configuring for said managing terminal communications with the sensor devices;
receiving at said managing terminal transmissions from said sensor devices over the network;
maintaining at said managing module a rules engine having stored a respective rule for each of said sensor devices, the rule for each device determining whether the managing module takes no action in response to a transmission from the associated device or takes an associated action in response to said transmission from said device.

19. The method of claim 18 wherein said action being selected from the group consisting of directing the sensor device to communicate with a recording device to record output data from the sensor device, sending a command to another sensor device to adjust a parameter thereof, and displaying on a display device at said managing terminal a display corresponding to the transmission of the sensor device.

20. The method of claim 18 and further comprising:
adding additional sensor devices in connection with the network; and
configuring said additional sensor devices for communication with said managing module.

21. The method of claim 18, wherein the rules of said rules engine controls the transmissions from said sensory devices.

22. The method of claim 21 and further comprising
displaying to a user on a display device of said managing terminal a map display wherein all of the sensor devices are indicated, and
receiving from a mouse of said managing terminal a click input identifying one of said sensor devices;
displaying on said display device an interactive window with control command interfaces for said sensor device;
receiving a further click input related to said interactive window from said mouse; and
outputting a command over the network to said sensor device.

23. The method of claim 22 wherein the sensor device is a movement controlled camera and the control command transmitted causes the camera to reposition itself.

24. The method of claim 18 wherein one of the sensor devices is a video camera, and the camera transmits streaming video therefrom to the managing terminal.

25. The method of claim 24 wherein the managing terminal displays said streaming video on a display monitor thereof.
